(19) United States
(12) Patent Application Publication
(10) Pub. No.: US 2008/0259665 A1
(43) Pub. Date: Oct. 23, 2008

(54) Rectifier Circuit, Circuit Arrangement and Method for Manufactiring a Rectifier Circuit

(76) Inventors: Ralf Brederlow, Poing (DE); Christian Pacha, Munchen (DE); Roland Thewes, Grobenzell (DE); Werner Weber, Munchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/629,941

(22) PCT Filed: May 18, 2005
(86) PCT No.: PCT/DE05/00907

§ 371 Date: Dec. 5, 2007

(30) Foreign Application Priority Data
Jun. 18, 2004 (DE) 10 2004 029 439.9

(51) Int. Cl. H02M 7/217

(52) U.S. Cl. 363/127

(57) ABSTRACT

One aspect of the invention relates to a rectifier circuit for providing a rectified voltage, with a first AC voltage terminal to which an AC voltage can be applied, with a first DC voltage terminal to which a DC voltage can be provided, and with a control switching element between the first AC voltage terminal and the first DC voltage terminal. The control switching element only couples the first AC voltage terminal to the first DC voltage terminal if the electrical potential at the first AC voltage terminal has a predeterminable polarity compared with a reference potential and if the amount of the electrical potential at the first DC voltage terminal is less than or equal to the amount of the electrical potential at the first AC voltage terminal.

### BACKGROUND

The invention relates to a rectifier circuit, a circuit arrangement and a method for manufacturing a rectifier circuit.

In an application with contactless electronic functionality such as a contactless chip card or a contactless identification data medium (so-called “ID Tag”), the electrical energy required for operating an associated circuit is frequently transferred by using an alternating electromagnetic field which, as a rule, is coupled into a circuit by means of an antenna. Such an antenna can be, for example, a coil if the energy is transferred inductively.

Since the operation of a circuit usually requires a DC voltage, the AC signal (for example an alternating current or an alternating voltage) usually picked up at terminals of the antenna must first be rectified and then smoothed and stabilized, if necessary. Usually, a rectifier circuit is used for this purpose.

Furthermore, there are applications in which an AC voltage applied to electrical contacts of a circuit is to be rectified for the circuit operation.

Furthermore, referring to FIG. 1A, a bridge rectifier circuit 100, known from the prior art, for rectifying an input AC voltage V_{IN} is described.

The rectifier circuit 100 has an AC voltage source 101 and interconnected first to fourth diodes 102 to 105. A first terminal of the AC voltage source 101 is coupled to a first terminal of the first diode 102, the second terminal of which is coupled to a first terminal of the fourth diode 105 and to a first DC voltage output terminal 106. Furthermore, the first terminal of the AC voltage source 101 is coupled to a first terminal of the second diode 103, the second terminal of which is coupled to a first terminal of the third diode 104 and to a second DC voltage output terminal 107. A second terminal of the AC voltage source 101 is coupled to the second terminal of the third diode 104 and to the second terminal of the fourth diode 105. Due to the functionality of the rectifier circuit 100, a DC voltage V_{OUT} generated from the AC voltage V_{IN} is provided between the DC voltage output terminals 106, 107. Furthermore, a filter capacitor 108 is provided between the terminals 106, 107 for smoothing the rectified output voltage.

FIG. 1B illustrates a diagram 110 along the abscissa 111 of which the voltage V_{D} between the two terminals of one of the diodes 102 to 105 is illustrated, and at the ordinate 112 of which the associated electrical current I_{D} flowing through the respective diode 102 to 105 is plotted. In FIG. 1B, the variation of a typical current/voltage characteristic of a semiconductor diode from one pn junction is outlined. In first approximation, the diode is cut off if a voltage is applied which is lower than a threshold voltage V_{T,D} of the diode. If a voltage above this threshold voltage is applied, the electrical current increases with great steepness with a rising voltage.

For silicon, which is a preferred material for the production of semiconductor diodes, the value of the threshold voltage V_{T,D} is typically between 0.6 V and 0.7 V due to material and production conditions. Since such a voltage must in each case be dropped across two diodes in the bridge rectifier circuit 100 illustrated in FIG. 1A, an output voltage V_{OUT} differing from zero can only be obtained if the peak-to-peak distance of the input AC voltage exceeds 1.2 V to 1.4 V.

In the further text, this situation is described with reference to the diagram 120 illustrated in FIG. 1C.

The peak-to-peak value V_{PP,IN} of an AC input voltage V_{IN} is illustrated along an abscissa 121 of diagram 120. A DC output voltage V_{OUT} is illustrated along an ordinate 122 of diagram 120. A first curve 123 illustrates the dependence of an output DC voltage on an input AC voltage in the case where a load is applied. A second curve 124 illustrates the theoretical limit, i.e. a curve without applied load.

Thus, the output DC voltage V_{OUT} is plotted against the peak-to-peak value of the input AC voltage V_{pp,IN} for a value of the threshold voltage of V_{T,D}=0.7 V in FIG. 1C. The maximum output DC voltage V_{OUT,max} which can be achieved can be described as:

V_{OUT,max}=V_{pp,IN}−2V_{T,D} (1)

In real applications, in which the output of the rectifier is loaded by current taken by the connected circuit, the output voltage is even below this value so that a value within the area 125 is typically obtained which lies between the first curve 123 and the second curve 124.

If R_{par,D} designates the parasitic series resistance of the diodes in FIG. 1C, the following is obtained for the maximum output DC voltage which can be achieved:

V_{OUT,max}=V_{pp,IN}−2(V_{T,D}+R_{par,D}I_{D}) (2)

The consequence of this observation is that at low values of the input AC voltage, a large proportion of the power fed in is consumed in the rectifier itself and not in the circuit operated by it and that, respectively, operation of the connected load (the circuit) is not possible for low available AC voltages or powers fed in due to the output DC voltage which can be achieved being too low.

Using Schottky diodes makes it possible to lower the value of the parameter V_{T,D} to approximately 200 mV to 300 mV. However, implementation of such diodes in a standard CMOS process means, on the one hand, increased expenditure and, on the other hand, the problem of high series resistances remains.

This disadvantageous ratio of output power to input power is obtained when the connected load must be operated at low supply voltage, due to, e.g., the maximum permissible supply voltage of circuits produced in modern CMOS processes.

Thus, rectifier circuits known from the prior art have a low efficiency, i.e. a low ratio of output power to input power.

### SUMMARY

One aspect of the invention provides a rectifier circuit which has a sufficiently high efficiency.

The rectifier circuit according to one embodiment of the invention for providing a rectified voltage has a first AC voltage terminal to which an AC voltage can be applied, and has a first DC voltage terminal at which a DC voltage can be provided. In addition, a control switching element is provided between the first AC voltage terminal and the first DC voltage terminal which only couples the first AC voltage terminal to the first DC voltage terminal if the electrical potential at the first AC voltage terminal has a predeterminable polarity compared with a reference potential, and if the amount of the electrical potential at the first DC voltage terminal is less than or equal to the amount of the electrical potential at the first AC voltage terminal.

Furthermore, according to one embodiment of the invention, a circuit arrangement is created which has a substrate and a rectifier circuit, formed on and/or in the substrate, having the features described above.

In the method according to one embodiment of the invention for producing a rectifier circuit for providing a rectified voltage, a first AC voltage terminal is formed at which an AC voltage can be applied. Furthermore, a first DC voltage terminal is formed at which a DC voltage can be provided. A control switching element is formed between the first AC voltage terminal and the first DC voltage terminal, wherein the control switching element only couples the first AC voltage terminal to the first DC voltage terminal if the electrical potential at the first AC voltage terminal has a predeterminable polarity compared with a reference potential and if simultaneously the amount of the electrical potential at the first DC voltage terminal is less than or equal to the amount of the electrical potential at the first AC voltage terminal.

A basic concept of one embodiment of the invention lies in providing a control switching element between an AC voltage terminal at which an electrical voltage is applied, and a DC voltage terminal at which a DC voltage which could be picked up can be provided, that the control switching element couples the AC voltage terminal and the DC voltage terminal at such a phase of the AC voltage signal at which a predeterminable polarity (positive or negative with respect to a reference potential) is present. As a result, to illustrate, electrical charge carriers of a particular sign (e.g. electrons) can be brought from the AC voltage terminal to the DC voltage terminal as a result of which an electrical potential of a predeterminable sign is generated at the DC voltage terminal. In contrast, the control switching element blocks and decouples the DC voltage terminal from the AC voltage terminal if the AC voltage signal has the complementary polarity to the predetermined polarity. This prevents an output voltage previously generated at a DC voltage terminal from being reduced again in that, to illustrate, charge carriers of a “wrong” charge carrier type are transferred from the AC voltage terminal to the DC voltage terminal.

Furthermore, a scenario can occur in which a signal of the correct polarity but of a very low amplitude is present at the AC voltage terminal (e.g. shortly after a zero transition of the AC voltage). If the amplitude of the DC voltage signal is greater than that of the AC voltage signal, coupling the AC voltage terminal to the DC voltage terminal in this scenario would lead to the disadvantageous effect that electrical charge carriers would undesirably flow back from the DC voltage terminal to the AC voltage terminal as a result of which the efficiency would be reduced. This fact has been recognized according to the invention and the functionality of the rectifier circuit has been improved in that the control switching element compares the amount of the potential at the DC voltage terminal with the amount of the potential at the AC voltage terminal and only establishes a coupling between DC voltage terminal and AC voltage terminal if the amount of the AC voltage signal is greater than that of the DC voltage signal. This ensures that coupling between DC voltage terminal and AC voltage terminal only takes place at the correct polarity, on the one hand, and, on the other hand, within this polarity also only within such time intervals of the AC voltage signal in which the amount of the former is greater than the DC voltage signal and thus leads to an accumulation of electrical charge carriers of the correct charge carrier type at the DC voltage terminal. According to the invention, this increases the efficiency of the rectifier circuit.

The polarity- and amount-dependent coupling/decoupling of DC voltage terminals and AC voltage terminals can be achieved by means of the most different components of electronics, for example by means of a field effect transistor. The comparison of the amounts of the electrical potential at DC voltage terminals and AC voltage terminal can be achieved, e.g. by means of a comparator, etc.

The control switching element is arranged as a controlling or regulating instance which detects the sign of a polarity of an AC voltage signal and compares the amount of the potential at a DC voltage terminal with the electrical potential at an AC voltage terminal. On the basis of this information, the control switching element regulates the coupling and decoupling, respectively, between AC voltage terminal and DC voltage terminal in such a manner that a very efficient rectifier circuit is obtained.

The rectifier circuit can have a first field effect transistor, the first source/drain terminal of which is coupled to the first AC voltage terminal and the second source/drain terminal of which is coupled to the first DC voltage terminal. By applying a suitable electrical potential to the gate terminal of the field effect transistor, the field effect transistor can be placed into a conductive or into a non-conductive (blocking) state and thus coupling or decoupling can be achieved between DC voltage terminal and AC voltage terminal.

Furthermore, the rectifier circuit can have a first comparator, the first input of which is coupled to the first AC voltage terminal, the second input of which is coupled to the first DC voltage terminal and the output of which is coupled to the gate terminal of the first field effect transistor. According to this embodiment, the current electrical potential of the first DC voltage terminal can be compared with that at the first AC voltage terminal at the inputs of the comparator and at the comparator output, an electrical potential can be provided which controls the gate area of the first field effect transistor in such a manner that the first field effect transistor becomes conducting only when the electrical potential at the first AC voltage terminal has a predetermined polarity compared with a reference potential and when simultaneously the amount of the electrical potential at the DC voltage terminal is less than or equal to the amount of the electrical potential at the first AC voltage terminal.

The interconnection of the first field effect transistor with the first comparator described represents a particularly simple and inexpensive implementation of the control switching element of the rectifier circuit. It avoids the disadvantages of rectifier circuits from the prior art which have a low efficiency. With suitable dimensioning, the first field effect transistor, which can also be called a rectifier transistor, has a much lower voltage drop than, e.g., the diodes in FIG. 1A. The rectifier circuit of one embodiment of the invention is thus advantageous particularly when an available AC voltage or a power irradiated via an antenna, in the case of poor distances between an ID tag and a reader, are so small that the peak-to-peak value of the available AC voltage is, e.g., only 1 V or less. In a scenario in which circuits produced in modern CMOS technology are used and in which the maximum permissible operating voltage is, e.g., 1.2 V or 1.5 V, the rectifier circuit according to one embodiment of the invention can also be used particularly advantageously.

In the rectifier circuit of one embodiment of the invention, a second AC voltage terminal can be provided, and a second field effect transistor, the first source/drain terminal of which is coupled to the second AC voltage terminal and the second source/drain terminal of which is coupled to the first DC voltage terminal. In the case of a second comparator, its first input can be coupled to the second AC voltage terminal and the second input can be coupled to the first DC voltage terminal. The output of the comparator can be coupled to the gate terminal of the second field effect transistor.

In the rectifier circuit of one embodiment of the invention, a second DC voltage terminal can also be created, and a third field effect transistor, the first source/drain terminal of which is coupled to the first AC voltage terminal and the second source/drain terminal of which is coupled to the second DC voltage terminal. The rectifier circuit can have a third comparator, the first input of which is coupled to the first AC voltage terminal, the second input of which is coupled to the second DC voltage terminal, and the output of which is coupled to the gate terminal of the third field effect transistor.

Moreover, the rectifier circuit can have a fourth field effect transistor, the first source/drain terminal of which is coupled to the second AC voltage terminal and the second source/drain terminal of which is coupled to the second DC voltage terminal. In the case of a fourth comparator of the rectifier circuit, its first input can be coupled to the second AC voltage terminal, its second input can be coupled to the second DC voltage terminal and its output can be coupled to the gate terminal of the fourth field effect transistor.

As an alternative to the two embodiments described last, a second DC voltage terminal can be provided in the rectifier circuit, and a third field effect transistor, the first source/drain terminal of which is coupled to the first AC voltage terminal and the second source/drain terminal of which is coupled to the second DC voltage terminal, wherein, moreover, a first inverter is provided, the input of which is coupled to the output of the second comparator and the input of which is coupled to the output of the second comparator, and the output of which is coupled to the gate terminal of the third field effect transistor.

In this embodiment, a fourth field effect transistor can also be provided, the first source/drain terminal of which is coupled to the second AC voltage terminal, and the second source/drain terminal of which is coupled to the second DC voltage terminal. The rectifier circuit can also have a second inverter, the input of which is coupled to the output of the first comparator and the output of which is coupled to the gate terminal of the fourth field effect transistor.

In an alternative embodiment, a second AC voltage terminal and a second DC voltage terminal can be provided, and the rectifier circuit can also have a second field effect transistor, the first source/drain terminal of which is coupled to the second AC voltage terminal and the second source/drain terminal of which is coupled to the first DC voltage terminal. Furthermore, a third field effect transistor can be provided, the first source/drain terminal of which is coupled to the first AC voltage terminal, and the second source/drain terminal of which is coupled to the second DC voltage terminal. A third comparator can be provided, the first input of which is coupled to the first AC voltage terminal, the second input of which is coupled to the second DC voltage terminal and the output of which is coupled to the gate terminal of the third field effect transistor. The rectifier circuit can be provided with a first inverter, the input of which is coupled to the output of the second comparator and the output of which is coupled to the gate terminal of the second field effect transistor.

The rectifier circuit can be interconnected in such a manner that at least one of the comparators and/or at least one of the inverters can be supplied with electrical energy by means of the DC voltage at the first and/or the second DC voltage terminal. According to this embodiment, the operating DC voltage required for operating the comparators and other circuit components, respectively, is taken from the rectified output voltage of the rectifier circuit. In this scenario, the circuit first settles and the operating voltage for the drive circuit parts is built up by those circuit sections which are driven by these drive elements. In addition, an electrical voltage, the amount of which is below the crest values of the input AC voltage, is also present at the gate terminals of rectifier transistors in the settled state. Larger amounts of voltage at these gates provide the rectifier transistors with higher conductivity in the switched-on state and the overall circuit with higher efficiency.

According to another embodiment, an additional rectifier circuit (e.g. a rectifier circuit according to the invention or a rectifier circuit known from the prior art such as, for example, the one illustrated in FIG. 1A) is provided which is interconnected in such a manner that at least one of the comparators and/or at least one of the inverters can be supplied with electrical energy by means of the additional rectifier circuit. In other words, the operating voltage for the comparators or for other circuit sections is generated by means of a separate rectifier in this case. This can be a rectifier known from the prior art or a rectifier according to the invention. Since the power needed for operating circuit sections (e.g. the comparators or the inverters) is low in many cases, such an additional rectifier circuit can be dimensioned in such a manner that its reduced efficiency is negligibly small when considering the overall rectifier circuit.

In another embodiment of the rectifier circuit, it is interconnected in such a manner that at least one of the comparators and/or at least one of the inverters can be supplied with electrical energy by means of the AC voltage at the first and/or the second AC voltage terminal. According to this embodiment, the operating voltages of the comparators and further circuit sections can be taken directly from the AC voltage source. If the correct polarity is present at the comparators (e.g. during a half wave of an AC voltage), the comparator can be operated by using the AC voltage, according to the invention, at least in this time interval.

At least one of the field effect transistors can be a polymer field effect transistor, a silicon-on-insulator (SOI) field effect transistor, a bulk silicon field effect transistor, a junction FET, a Fin-FET or a dual gate field effect transistor.

The AC voltage can be provided by means of an AC voltage element which is in one example an antenna, a coil or an AC voltage source.

When using a coil as AC voltage element, it can be provided with a center tap at which an electrical reference potential can be provided. For example, the center tap of the coil can be connected to the electrical ground potential.

In one example, at least a part of the circuit components of the rectifier circuit according to the invention is implemented in polymer electronics or silicon microelectronics.

In the further text, the circuit arrangement according to the invention, which has a rectifier circuit according to the invention, is described in greater detail. Embodiments of the rectifier circuit also apply to the circuit arrangement and vice versa.

The circuit arrangement can be set up as contactless chip card or identification data medium (“ID tag”, for example an RFID (Radio Frequency Identification) data medium, e.g. a transponder) or installed in such a device. In these applications, the advantages of the rectifier circuit are apparent, namely in the simple configuration, inexpensive production and sufficiently good functionality with low losses in providing a DC voltage.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1A illustrates a rectifier circuit known from the prior art.

FIG. 1B illustrates a current/voltage characteristic of diodes interconnected in the rectifier circuit from FIG. 1A.

FIG. 1C illustrates a diagram which illustrates the output DC voltage, which can be achieved with the rectifier circuit from FIG. 1A, in dependence on an input AC voltage.

FIG. 2 illustrates a rectifier circuit according to a first exemplary embodiment of the invention.

FIG. 3 illustrates a rectifier circuit according to a second exemplary embodiment of the invention.

FIG. 4 illustrates a rectifier circuit which is a precursor of a rectifier circuit according to the invention.

FIG. 5 illustrates an arrangement of diagrams from which the functionality of a rectifier circuit according to the invention can be seen.

FIG. 6 illustrates a rectifier circuit according to a third exemplary embodiment of the invention.

FIG. 7 illustrates a rectifier circuit according to a fourth exemplary embodiment of the invention.

FIG. 8 illustrates a rectifier circuit according to a fifth exemplary embodiment of the invention.

FIG. 9 illustrates a rectifier circuit according to a sixth exemplary embodiment of the invention.

FIG. 10A to FIG. 10C illustrate part areas of the rectifier circuit illustrated in FIG. 9.

FIG. 11 illustrates a rectifier circuit according to a seventh exemplary embodiment of the invention.

FIG. 12A to FIG. 12C illustrate part areas of the rectifier circuit illustrated in FIG. 11.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

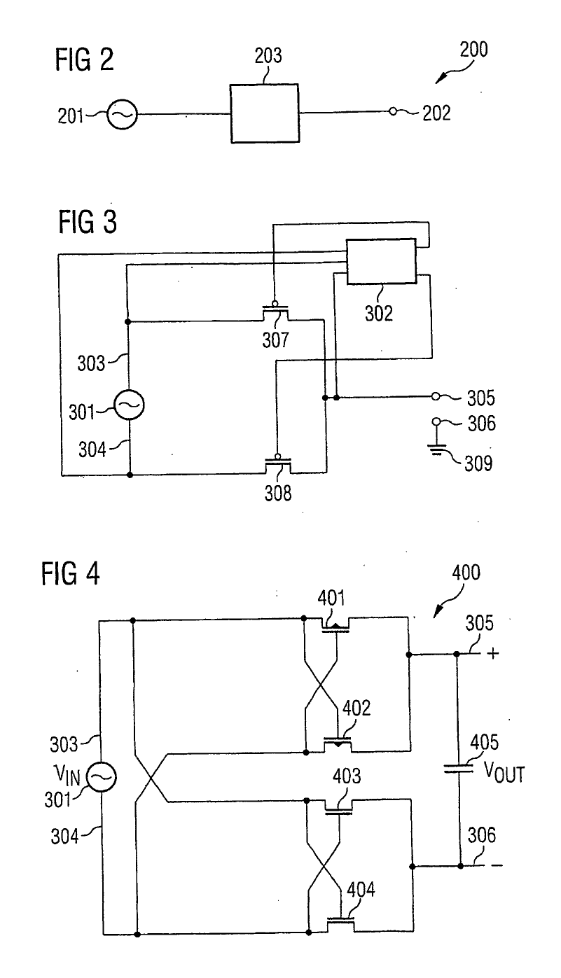

In the further text, a rectifier circuit 200 according to a first exemplary embodiment of the invention is described with reference to FIG. 2.

The rectifier circuit 200 is used for providing a rectified voltage and contains an AC voltage terminal 201 at which an AC voltage is applied. Furthermore, the rectifier circuit 200 contains a DC voltage terminal 202 at which a rectified DC voltage is provided. A control switching element 203 between the AC voltage terminal 201 and the DC voltage terminal 202 only couples the AC voltage terminal 201 to the DC voltage terminal 202 if the electrical potential at the AC voltage terminal 201 has an electrically positive polarity compared with the ground potential as reference potential and if, simultaneously, the amount of the electrical potential at the DC voltage terminal 202 is less than or equal to the amount of the electrical potential at the AC voltage terminal 201.

To illustrate, the control switching element 203 can thus be considered as a regulating device which, on the basis of the electrical potentials at the AC voltage terminal 201 and at the DC voltage terminal 202, only establishes an electrically conductive coupling between the AC voltage terminal 201 and the DC voltage terminal 202 if the present potential of the AC voltage has the positive polarity of a required positive DC voltage to be provided and if the electrical potential with the positive polarity at the AC voltage terminal 201 has a higher amount than the amount at the DC voltage terminal 202 at a particular time, as a result of which an unwanted flowing-back of electrical charge carriers from the DC voltage terminal 202 to the AC voltage terminal 201 is avoided and thus the efficiency of the rectifier circuit is increased.

In the further text, a rectifier circuit 300 according to a second exemplary embodiment of the invention is described with reference to FIG. 3.

The rectifier circuit 300 has an AC voltage source 301 which is connected in operative connection with a control switching element 302 in such a manner that an electrical DC voltage is generated. The AC voltage source 301 is connected between a first AC voltage terminal 303 and a second AC voltage terminal 304 and provides a DC voltage between a first DC voltage terminal 305 and a second DC voltage terminal 306 which is brought to the electrical ground potential 309. For this purpose, a first PMOS field effect transistor 307 and a second PMOS field effect transistor 308 are interconnected with the control switching element 302 and with the AC voltage sources 301.

The first AC voltage terminal 303 is coupled to a first source/drain terminal of the first PMOS field effect transistor 307 and to a first input of the control switching element 302. The first source/drain terminal of the second PMOS field effect transistor 308 is coupled to a second input of the control switching element 302 and to the second AC voltage terminal 304. The second source/drain terminals of the first PMOS field effect transistor 307 and the second PMOS field effect transistor 308 are coupled to one another and to the first DC voltage terminal 305. A third input of the control switching element 302 is coupled to the first DC voltage terminal 305. A first output of the control switching element 302 is coupled to the gate terminal of the first PMOS field effect transistor 307. A second output of the control switching element 302 is coupled to the gate terminal of the second PMOS field effect transistor 308.

The control switching element 302 thus controls the electrical potentials at the gate terminals of the PMOS field effect transistors 307, 308 and thus determines, on the basis of a comparison of the present electrical potentials at the three inputs of the control switching element 302 whether the AC voltage terminals 303, 304 are coupled to the first DC voltage terminal 305 or not.

If, e.g. in a particular operating state of the AC voltage source 301, an electrical potential is present at the first AC voltage terminal 303 which is positive compared with an electrical reference potential (e.g. the electrical ground potential), the control switching element 302 adjusts the electrical potential at the gate terminal of the second PMOS field effect transistor 308 in such a manner that the second PMOS field effect transistor 308 is cut off. In contrast, the control switching element 302 adjusts the electrical potential at the gate terminal of the first PMOS field effect transistor 307 in such a manner that the first PMOS field effect transistor 307 conducts since a negative electrical potential is present at the second AC voltage terminal 304 in this operating state. As a result, an electrically conductive connection is established between the first AC voltage terminal 303 and the first DC voltage terminal 305. However, the control switching element 302 establishes an electrically conductive connection between the second source/drain terminal of the conducting PMOS field effect transistor 307 and the first DC voltage terminal 305 when the amount of the positive electrical potential at the first DC voltage terminal 305 is less than the amount of the (currently positive) electrical potential at the first AC voltage terminal 303. If these two conditions are cumulatively met (namely firstly that the electrical potential at the first AC voltage terminal 303 is positive compared with the reference potential and that secondly the amount of the electrical potential is less at the first DC voltage terminal 305 than at the first AC voltage terminal 303), an electrically conductive connection is established between the first AC voltage terminal 303 and the first DC voltage terminal 305 by means of the control switching element 302 so that electrical charge carriers of the correct charge carrier type are transferred from the first AC voltage terminal 303 to the first DC voltage terminal 305. As a result, a DC voltage is progressively built up between the first and the second DC voltage terminal 305, 306. Unwanted charge carrier flow-back from the first DC voltage terminal 305 into the AC voltage source 301 is avoided.

In the further text, a rectifier circuit 400 which represents a precursor of a rectifier circuit according to the invention according to a third exemplary embodiment of the invention is illustrated with reference to FIG. 4 and by means of which an important aspect of the invention is described.

The rectifier circuit 400 again contains an AC voltage source 301 which provides an AC voltage between a first AC voltage terminal 303 and a second AC voltage terminal 304. A DC voltage is provided between a first DC voltage terminal 305 and a second DC voltage terminal 306. The first AC voltage terminal 303 is coupled to a first source/drain terminal of a first PMOS field effect transistor 401 and is coupled to the gate terminal of a second PMOS field effect transistor 402, the second source/drain terminals of the first and of the second PMOS field effect transistors 401, 402 being coupled to one another and to the first DC voltage terminal 305. Furthermore, the first AC voltage terminal 303 is coupled to a first source/drain terminal of a first NMOS field effect transistor 403 and to the gate terminal of a second NMOS field effect transistor 404. The gate terminal of the first NMOS field effect transistor 403 and the first source/drain terminal of the second NMOS field effect transistor 404 are coupled to the second AC voltage terminal 304, to the gate terminal of the first PMOS field effect transistor 401 and to the first source/drain terminal of the second PMOS field effect transistor 402. The second source/drain terminals of the first NMOS field effect transistor 403 and of the second NMOS field effect transistor 404 are coupled to the second DC voltage terminal 306. Between the first DC voltage terminal 305 and the second DC voltage terminal 306, a filter capacitor 405 is connected. Between the first second DC voltage terminals 305, 306, an output DC voltage V_{OUT} is provided which is formed from the input AC voltage V_{IN}.

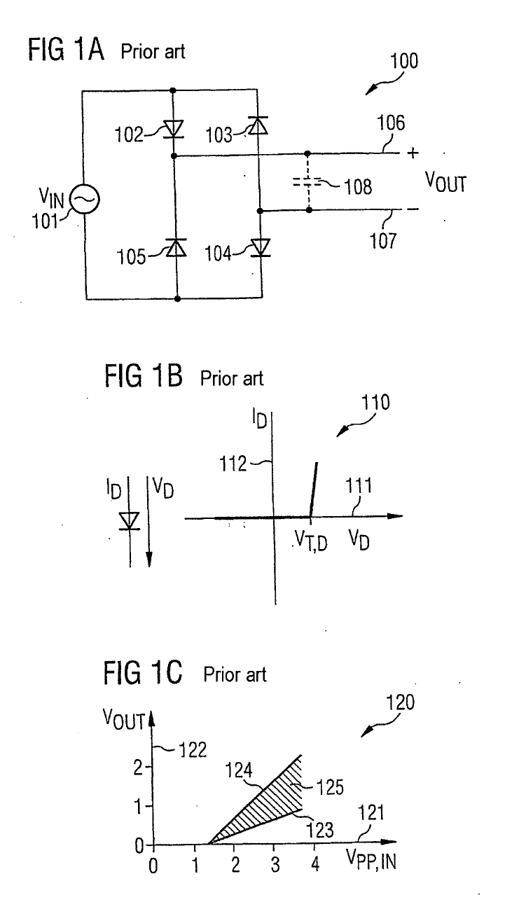

The rectifier circuit 400 with the cross-connected field effect transistors 401 to 404 has the advantage that, with suitable dimensioning, the voltage drops across the rectifier transistors 401 to 404, compared with the bridge rectifier circuit 100 of silicon diodes 102 to 104, are much lower than in the circuit from FIG. 1A. To illustrate, the transistors 401 to 404 are operated as three-terminal components and not as two-terminal components like the diodes from FIG. 1A.

In the rectifier circuit 400, the rectification is based on the following aspect: if a positive electrical potential is present, e.g. at the first AC voltage terminal 303 of the voltage source 301 V_{IN}, a negative electrical potential is present at the second AC voltage terminal 304. As a result, the first PMOS transistor 401 is switched on, the second PMOS transistor 402 is switched off, and the positive electrical potential at the first AC voltage terminal 303 is forwarded to the first DC voltage terminal 305 which is to supply the positive DC voltage potential. In the next half-wave of the exciting AC voltage 301, a negative electrical potential is present at the first AC voltage terminal 303 and a positive electrical potential is present at the second AC voltage terminal 304 so that, in this scenario, the second PMOS transistor 402 conducts and the first PMOS field effect transistor 401 is cut off and the positive electrical potential at the second AC voltage terminal 304 is thus delivered to the first DC voltage terminal 305 which represents the positive DC voltage potential.

An analogous argument is obtained for the negative output DC voltage of the circuit which is provided via the first NMOS transistor 403 and via the second NMOS transistor 404, taking into consideration the fact that these NMOS transistors 403, 404 are switched on with a positive gate voltage and switched off with a negative gate voltage.

In the circuit 400 which only represents a precursor of the rectifier circuit 600 according to a third exemplary embodiment of the invention, described with reference to FIG. 6 in the further text, it is disadvantageous, however, that a charge flow-back from the DC voltage terminals 305, 306 into the input AC voltage source 301 is possible in a disadvantageous scenario, as a result of which the efficiency of the rectifier circuit 400 is not optimal.

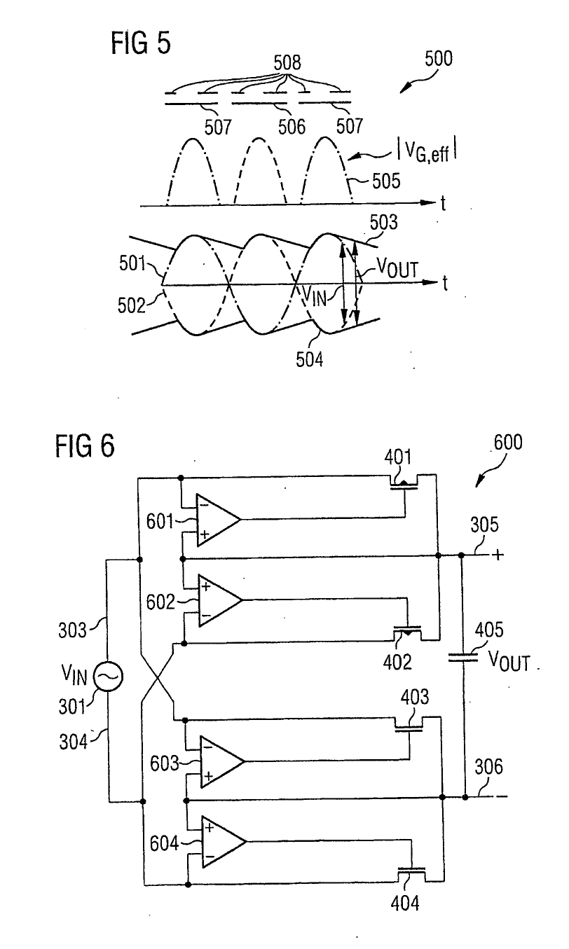

FIG. 5 illustrates a diagrammatic drawing in which sign and amount of different electrical potentials at terminals of the rectifier circuit 400 are illustrated.

In a lower section of FIG. 5, both phases of the input AC voltage and the positive or negative output voltage of the rectifier circuit 400 are plotted as a function of time. In particular, FIG. 5 illustrates a first input AC voltage phase 501, i.e. the potential variation at the first AC voltage terminal 303. Furthermore, a second input AC voltage phase 502 is illustrated, i.e. the variation of the electrical potential at the second AC voltage terminal 304. Furthermore, the variation of the first output DC voltage potential 503 at the first DC voltage terminal 305 with time is illustrated in the lower section of FIG. 5. In addition, FIG. 5 illustrates the variation of the second output DC voltage potential 504, which is present at the second DC voltage output terminal 306, with time.

In the center area of FIG. 5, the amount of the effective gate voltage |V_{G,eff}| 505 of the transistors of transistors 401 to 404 switched on in each case is illustrated.

In the top section of FIG. 5, it is indicated within what periods the transistors 401 to 404 are switched on. Within a first switching phase 506, the second PMOS field effect transistor 402 and the first NMOS field effect transistor 403 conduct, whereas in a second switching phase 507, the first PMOS field effect transistor 401 and the second NMOS field effect transistor 404 conduct. During charge flow-back time intervals 508, an unwanted flow-back of electrical charge carriers from the DC voltage terminals 305, 306 to the AC voltage terminals 303, 304, i.e. back into the AC voltage source 301, occurs in the rectifier circuit 400 which reduce the efficiency of the circuit.

As can be seen from FIG. 5, a situation occurs in each case at the beginning and at the end of these time intervals that the positive (or negative) output voltage is greater (or less) than the current value of the voltage at the node of the input voltage source 301 to which the output 305 or 306 is currently coupled via the transistors 401 to 404. These time intervals, in which this occurs, are identified in FIG. 5 by the bars 508. In these time intervals, charge flow-back thus occurs from the output to the input of the circuit.

In the rectifier circuit 600 according to a third exemplary embodiment of the invention, illustrated in FIG. 6, the problems with the charge flow-back occurring in the rectifier circuit 400 are effectively avoided.

In the further text, the structure of the rectifier circuit 600 is described.

The first AC voltage terminal 303 which is coupled to the AC voltage source 301 is also coupled to a first source/drain terminal of a first PMOS field effect transistor 401, to the first source/drain terminal of a first NMOS field effect transistor 403, to a negative input of a first comparator 601 and to a negative input of a third comparator 603. The second AC voltage terminal 304 is coupled to the first source/drain terminal of the second PMOS field effect transistor 402, to a negative input of a second comparator 602, to a first source/drain terminal of the second PMOS field effect transistor 404 and to a negative input of a fourth comparator 604. The second source/drain terminal of the first PMOS field effect transistor 401, the positive input of the first comparator 601, the second source/drain terminal of the second PMOS field effect transistor 402 and the positive input of the second comparator 602 are coupled to the first DC voltage terminal 305. Furthermore, a second source/drain terminal of the first NMOS field effect transistor 403, a positive terminal of the third comparator 603, a second source/drain terminal of the second PMOS field effect transistor 404 and a positive input of the fourth comparator 604 are coupled to the second DC voltage terminal 306. Between the first DC voltage terminal 305 and the second DC voltage terminal 306, a filter capacitor 405 is provided for smoothing the rectified output voltage. Furthermore, the output of the first comparator 601 is coupled to the gate terminal of the first PMOS field effect transistor 401. The output of the second comparator 602 is coupled to the gate terminal of the second PMOS field effect transistor 402. The gate terminal of the third comparator 603 is coupled to the gate terminal of the first NMOS field effect transistor 403. The output of the fourth comparator 604 is coupled to the gate terminal of the second NMOS field effect transistor 404.

In the further text, the functionality of the rectifier circuit 600 is described in greater detail.

Using the first to fourth comparators 601 to 604, the source/drain potentials of the rectifier transistors 401 to 404 at the DC voltage side and the AC voltage side are in each case compared and the comparator outputs drive the gates of the rectifier transistors 401 to 404 in such a manner that in the case of transistors 401, 402 (or 403 and 404, respectively) which supply the positive (or negative, respectively) DC voltage potential, those transistors are switched into the conducting state (i.e. that their gate potential is negative (or positive, respectively), when the positive (or negative, respectively) output voltage at the DC voltage side is less than (or greater, respectively) than the input voltage at the AC voltage side.

To illustrate, the interconnection of the AC voltage source 301 with the rectifier transistors 401 to 404 and the comparators 601 to 604 according to the invention generates a rectified voltage of predeterminable or arbitrary sign with a simple and inexpensive circuit architecture. The transistors 401 to 404 operated as three-terminal components can be operated at even lower voltages than the diodes from FIG. 1A. Furthermore, the rectifier circuit 600 effectively prevents an unwanted charge carrier flow-back from the output terminals 305, 306 to the input terminals 303, 304 from occurring. This is achieved by the interconnection of the transistors 401 to 404 with the comparators 601 to 604 illustrated. To illustrate, according to the invention, a regulating mechanism is created which in a particularly advantageous manner switches the transistors 401 to 404 to and fro between the conducting and the nonconducting state. For this purpose, it is not only the sign, i.e. the polarity, of an electrical potential (e.g. referred to an electrical reference potential) at input AC voltage terminals 303, 304 which is considered but in addition the amount of the electrical potential between the respective output terminal 305 (or 306) and the associated input terminal 303 (or 304, respectively) is compared so that the blocked state of the transistors 401 to 404 is maintained even with correct polarity but too small an amount of the potential currently present at the input terminals 303, 304, as a result of which an unwanted charge carrier flow-back is prevented.

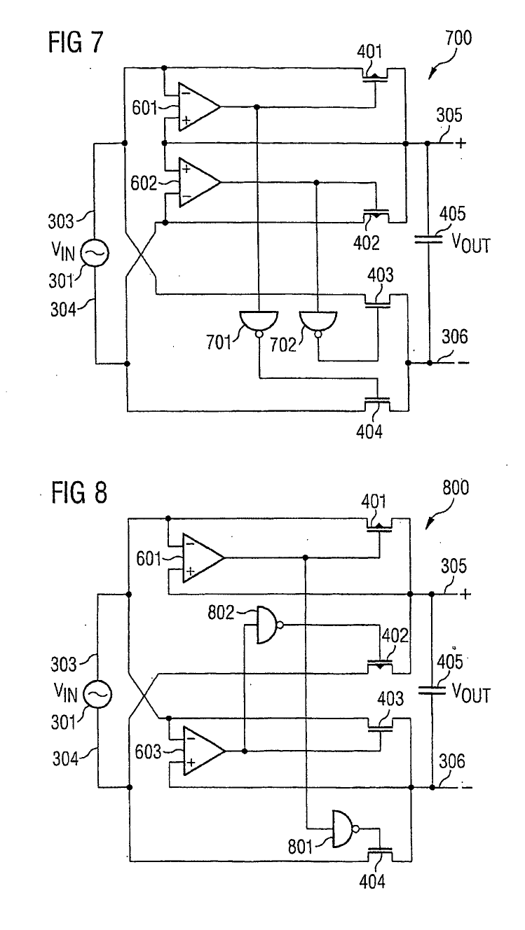

In the further text, a rectifier circuit 700 according to a fourth exemplary embodiment of the invention is described with reference to FIG. 7.

The rectifier circuit 700 illustrated in FIG. 7 differs from the rectifier circuit 600 illustrated in FIG. 6 essentially in that the third and fourth comparators 603, 604 are saved in FIG. 7 and that a first inverter 701 and a second inverter 702 are additionally provided. The output of the first comparator 601 is coupled to an input of the first inverter 701, the output of which is coupled to the gate terminal of the second NMOS field effect transistor 404. Furthermore, the output of the second comparator 602 is coupled to an input of the second inverter 702, the output of which is coupled to the gate terminal of the first NMOS field effect transistor 403.

For reasons of symmetry, it applies to many applications that a positive voltage drop between source/drain nodes at the AC voltage side and the DC voltage side of the transistors 401 and 402, respectively, is correlated with a negative voltage drop between source/drain nodes at the AC voltage side and the DC voltage side of the transistors 403, 404, and that a negative voltage drop between source/drain nodes at the AC voltage side and the DC voltage side of the transistors 401 and 402, respectively, is correlated with a positive voltage drop between source/drain nodes at the AC voltage side and DC voltage side of the transistors 403 and 404, respectively.

For this reason, two comparators instead of four comparators are sufficient as is implemented in the exemplary embodiment illustrated in FIG. 7. The outputs of the first and second comparators 601, 602 can be used in each case for driving a transistor 401 and 402, respectively, directly and a complementary transistor 403 and 404, respectively, after inversion of the comparator output signal by using the first inverter 701 and the second inverter 702, respectively. The two comparators 601, 602 implemented are active in complementary manner in both half waves of the input AC voltage since in each case a pair of the rectifier transistors, i.e. first PMOS field effect transistor 401 and second NMOS field effect transistor 404, or second PMOS field effect transistor 402 and first NMOS field effect transistor 403 can be activated in in each case one of the two half waves.

FIG. 7 illustrates a configuration in which in each case one of the comparators 601, 602 is coupled to in each case one pole 303 and 304, respectively, of the AC voltage source 301 and either to the positive or to the negative pole 305 or 306 of the output DC voltage.

In the further text, a rectifier circuit 800 according to a fourth exemplary embodiment of the invention is described with reference to FIG. 8.

The rectifier circuit 800 illustrated in FIG. 8 differs from the rectifier circuit 600 illustrated in FIG. 6 essentially in that the second comparator 602 and the fourth comparator 604 are saved and that a first inverter 801 and a second inverter 802 are additionally interconnected in FIG. 8. The output of the first comparator 601 is coupled to the input of the first inverter 801, the output of which is coupled to the gate terminal of the second NMOS field effect transistor 404. Furthermore, the output of the third comparator 603 is coupled to an input of the second inverter 802, the output of which is coupled to the gate terminal of the second PMOS field effect transistor 402.

FIG. 8 thus illustrates a configuration in which both comparators 601, 603 are connected at the same pole, namely the first AC voltage terminal 303 of the AC voltage source 301, but the comparators 601, 603 compare the potentials of both poles 305 and 306, respectively, of the output DC voltage.

This ensures the possible activation (switching of the rectifier transistors 401 to 404 into the conducting state) in both half waves of the input AC voltage.

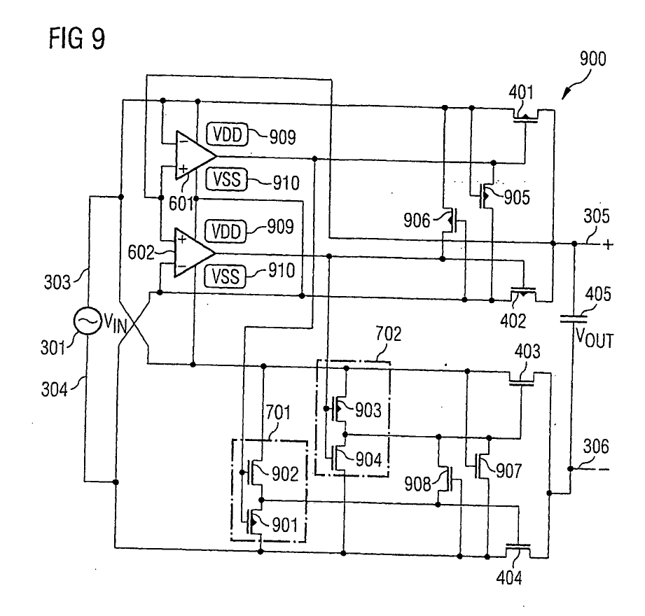

In the further text, a rectifier circuit 900 according to a fifth exemplary embodiment of the invention is described with reference to FIG. 9.

In the rectifier circuit 900, which resembles the rectifier circuit 700, the internal interconnection of the first inverter 701 and of the second inverter 702 is illustrated. The first inverter 701 is implemented by means of a first PMOS inverter transistor 901 and by means of a first NMOS inverter transistor 902 which are interconnected with one another in inverter connection. The second inverter 702 is implemented by means of a second PMOS inverter transistor and by means of a second NMOS inverter transistor 904, which transistors 903, 904 are interconnected in inverter connection. Furthermore, FIG. 9 illustrates a first PMOS switching transistor 905, the first source/drain terminal of the first PMOS switching transistor 905 being coupled to the output of the first comparator 601, the second source/drain terminal of the first NMOS switching transistor 905 being coupled to the second AC voltage terminal 304 and the gate terminal of the first PMOS switching transistor 905 being coupled to the first AC voltage terminal 303. In the case of a second PMOS switching transistor 906, a first source/drain terminal is coupled to the first AC voltage terminal 303, a second source/drain terminal is coupled to the output of the second comparator 602 and the gate terminal is coupled to the second AC voltage terminal 304. In the case of a first NMOS switching transistor 907, a first source/drain terminal is coupled to the output of the second inverter 702, the second source/drain terminal is coupled to the second AC voltage terminal 304, and the gate terminal is coupled to the first AC voltage terminal 303. In the case of a second NMOS switching transistor 908, a first source/drain terminal is coupled to an output of the second inverter 702, a second source/drain terminal is coupled to the output of the first inverter 701 and a gate terminal is coupled to the second AC voltage terminal 304.

In the further text, the rectifier circuit 900 is used for describing how, according to an exemplary embodiment of the invention, the voltage supply of the comparators 601, 602 and of all circuit sections used for driving the rectifier transistors 401 to 404 is implemented.

As illustrated in FIG. 9, the operating voltage of the comparators 601, 602 and further voltage sections is taken directly from the AC voltage source 301 for this purpose. The designations VDD and VSS represent the terminals of the comparator circuit to which the positive and the negative operating DC voltage would be applied in normal operation. For this purpose, an upper operating voltage potential 909 VDD and a lower operating voltage potential 910 VSS is illustrated in FIG. 9. As can be seen from the circuit of FIG. 9, the correct polarity is thus present at both comparators 601, 602 and in in each case one half wave, a negative/positive voltage is present at the positive/negative operating voltage terminal during the other half wave.

During the operation with correct polarity, the comparators 601, 602 are operated by means of the potentials provided. The output of the comparators 601, 602 drives the gate of a respective rectifier transistor 401 and 402, respectively, directly, the gate of a further transistor 403 and 404, respectively, is driven by a respective inverter 701 and 702, respectively. When the polarity is reversed, both the output of the comparator 601, 602 and that of the associated inverter 701 and 702, respectively, go into a high-impedance state. To prevent an undefined potential from being present at the gate terminals of the rectifier transistors 401 to 404 in this case, first to fourth switching transistors 905 to 908 are inserted into the circuit. These load the gate terminal of the rectifier transistors 401 to 404 during the half wave of the input AC voltage during which the corresponding rectifier transistors 401 to 404 should always be cut off, with the highest available positive (negative) voltage in the case of the PMOS (NMOS) transistors so that the operating point is defined and cutting-off of the transistor is guaranteed.

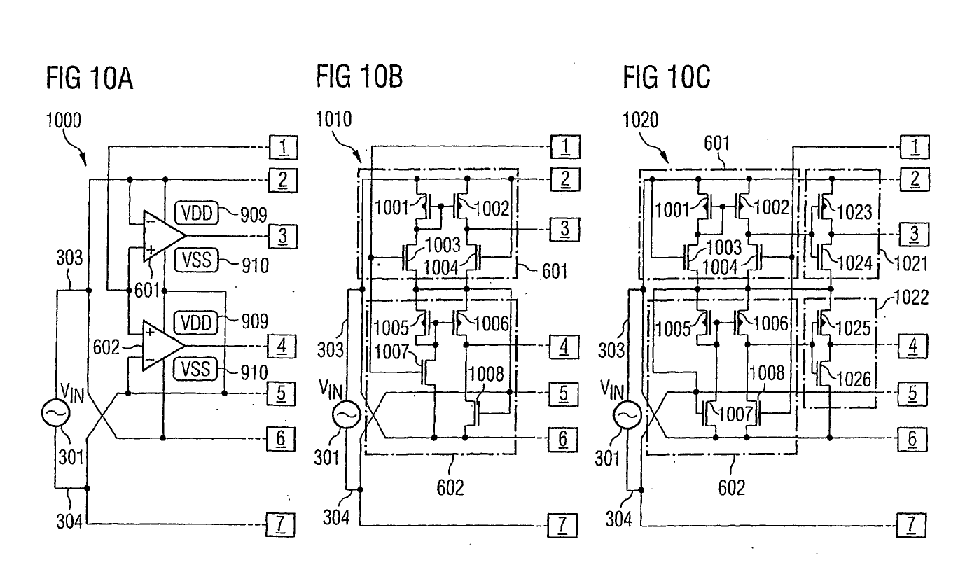

In the further text, part views of the rectifier circuit 900 are described with reference to FIG. 10A to FIG. 10C.

FIG. 10A illustrates a part view 1000 of the rectifier circuit 900. The part view 1010 of FIG. 10B illustrates the internal interconnection of the first and of the second comparator 601, 602 of part view 1000.

In part view 1010, the first comparator 601 is implemented by means of a first PMOS comparator transistor 1001, the first source/drain terminal of which is coupled to a first source/drain terminal of a first NMOS comparator transistor 1003. The second source/drain terminal of the first PMOS comparator transistor 1001 is coupled to a first source/drain terminal of a second PMOS comparator transistor 1002, the second source/drain terminal of which is coupled to a first source/drain terminal of a second NMOS comparator transistor 1004. The gate terminal of the first PMOS comparator transistor 1001 is coupled to its first source/drain terminal and to the gate terminal of the second PMOS comparator transistor 1002. FIG. 10B illustrates the internal interconnection of a third PMOS comparator transistor 1005, of a fourth PMOS comparator transistor 1006, of a third NMOS comparator transistor 1007 and of a fourth NMOS comparator transistor 1008 of the second comparator 602. This interconnection corresponds to that of transistors 1001 to 1004 in the first comparator 601.

The implementation of the comparators 601, 602 illustrated in part view 1010 is formed by using a so-called quasi differential stage of the in each case four transistors 1001 to 1004 and 1005 to 1008, respectively, which allows an operation at very low voltages.

In the further text, a part view 1020 of the rectifier circuit 900 in which a further improvement in the form of a third inverter 1021 and a fourth inverter 1022 is implemented, is described with reference to FIG. 10C.

In FIG. 10C, the internal structure of the first and of the second comparator 601, 602 is implemented as in FIG. 10B. Furthermore, a third inverter 1021 and a fourth inverter 1022 are provided at the output of the comparators 601, 602, respectively. The third inverter 1021 is formed of a third PMOS inverter transistor 1023 and of a third NMOS inverter transistor 1024 which are interconnected in inverter connection. Furthermore, the fourth inverter 1022 is formed of a fourth PMOS inverter transistor 1025 and of a fourth NMOS inverter transistor 1026 which are interconnected in inverter connection. The third and fourth inverters 1021, 1022 follow the comparator stages 601, 602 to increase the amplification. Due to the additional inversion by these stages, the inputs of the transistors 1001, 1002, 1005, 1006 are exchanged compared with FIG. 10B.

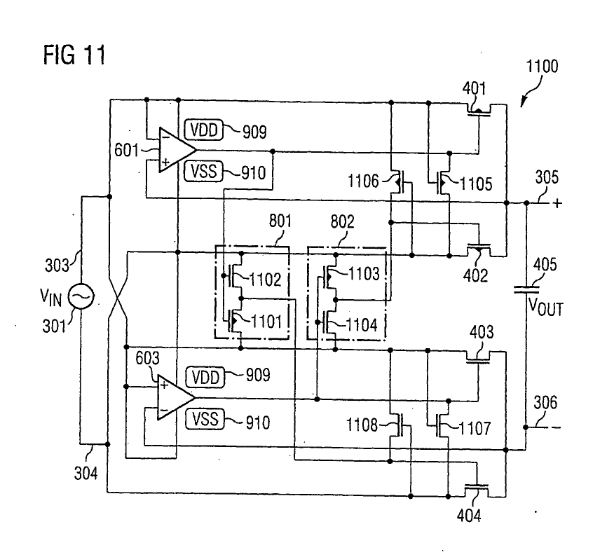

In the further text, a rectifier circuit 1100 according to a sixth exemplary embodiment of the invention is described with reference to FIG. 11.

The rectifier circuit 1100 resembles the rectifier circuit 800 illustrated in FIG. 8 and represents a further improvement compared with this circuit. In the rectifier circuit 1100, the internal interconnection of the first inverter 801 and of the second inverter 802 is illustrated. The first inverter 801 is formed by means of a first PMOS inverter transistor 1101 and by means of a first NMOS inverter transistor 1102 which are interconnected in inverter connection. The second inverter 802 is formed by means of a second PMOS inverter transistor 1103 and by means of a second NMOS inverter transistor 1104 which are interconnected in inverter connection. Furthermore, in FIG. 11, four switching transistors 1105 to 1108 are also provided similar to FIG. 10, namely a first PMOS switching transistor 1105, a second PMOS switching transistor 1106, a first NMOS switching transistor 1107 and a second NMOS switching transistor 1108. The switching transistors 1105 to 1108 are provided for preventing an undefined potential from being present at the gates of the rectifier transistors 401 to 404.

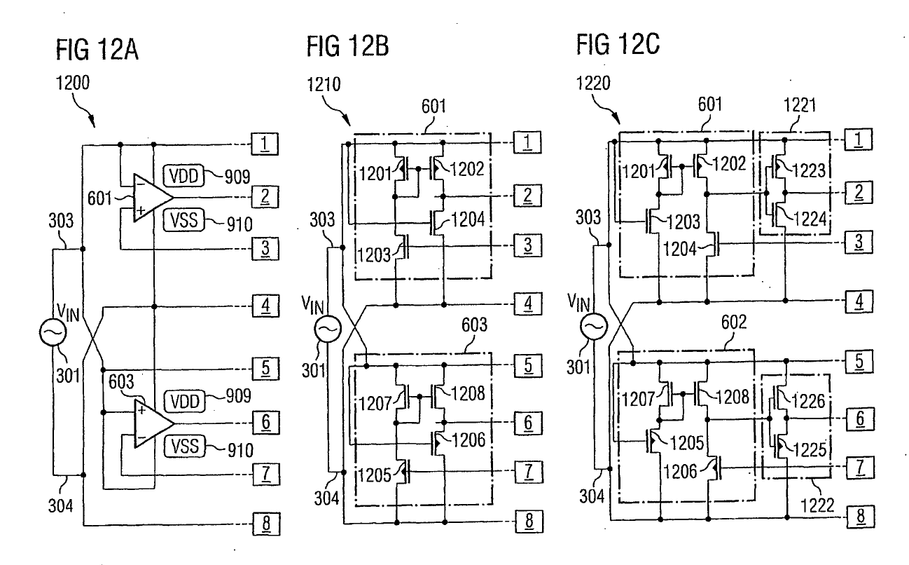

FIG. 12A illustrates a part view 1200 of the rectifier circuit 1100 from FIG. 11. FIG. 12B illustrates a part view 1210 wherein, in distinction from the part view 1200, the internal interconnection of the first comparator 601 and of the third comparator 603 is illustrated. The first comparator 601 is implemented by using a first PMOS comparator transistor 1201, a second PMOS comparator transistor 1202, a first NMOS comparator transistor 1203 and a second NMOS comparator transistor 1204, the transistors 1201 to 1204 being interconnected with one another in such a manner that the internal interconnection of the transistors 1201 to 1204 essentially corresponds to the interconnection of the transistors from 1001 to 1004 from FIG. 10B. Furthermore, the third comparator 603 is implemented by means of a third PMOS comparator transistor 1205, a fourth PMOS comparator transistor 1206, a third NMOS comparator transistor 1207 and a fourth NMOS comparator transistor 1208 which are interconnected similarly to transistors 1005 to 1008 from FIG. 10B. Furthermore, the first comparator 601 is followed by a third inverter 1221 which is formed of a third PMOS inverter transistor 1223 and of a third NMOS inverter transistor 1224 which are connected in inverter connection. In addition, the second comparator 602 is followed by a fourth inverter 1222 which is formed of a fourth PMOS inverter transistor 1225 and of a fourth NMOS inverter transistor 1226.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1-20. (canceled)

21. An integrated circuit arrangement comprising:
a substrate;
a first AC voltage terminal on the substrate to which an AC voltage can be applied;
a first DC voltage terminal on the substrate to which a DC voltage can be provided;
means between the first AC voltage terminal and the first DC voltage terminal for coupling the first AC voltage terminal to the first DC voltage terminal if the electrical potential at the first AC voltage terminal has a predeterminable polarity compared with a reference potential and if the amount of the electrical potential at the first DC voltage terminal is less than or equal to the amount of the electrical potential at the first AC voltage terminal.

22. The circuit arrangement as claimed in claim 21 configured as a contactless chip card.

23. The circuit arrangement as claimed in claim 21 configured as an identification data medium.

24. A rectifier circuit for providing a rectified voltage, the integrated circuit comprising:
a first AC voltage terminal to which an AC voltage can be applied;
a first DC voltage terminal to which a DC voltage can be provided;
a control switching element between the first AC voltage terminal and the first DC voltage terminal which only couples the first AC voltage terminal to the first DC voltage terminal, if the electrical potential at the first AC voltage terminal has a predeterminable polarity compared with a reference potential and if the amount of the electrical potential at the first DC voltage terminal is less than or equal to the amount of the electrical potential at the first AC voltage terminal.

25. The rectifier circuit as claimed in claim 24 further comprising a first field effect transistor, the first source/drain terminal of which is coupled to the first AC voltage terminal and the second source/drain terminal of which is coupled to the first DC voltage terminal.

26. The rectifier circuit as claimed in claim 25 further comprising a first comparator, the first input of which is coupled to the first AC voltage terminal, the second input of which is coupled to the first DC voltage terminal and the output of which is coupled to the gate terminal of the first field effect transistor.

27. The rectifier circuit as claimed in claim 24 further comprising:
a second AC voltage terminal;
a second field effect transistor, the first source/drain terminal of which is coupled to the second AC voltage terminal and the second source/drain terminal of which is coupled to the first DC voltage terminal; and
a second comparator, the first input of which is coupled to the second AC voltage terminal, the second input of which is coupled to the first DC voltage terminal, and the output of which is coupled to the gate terminal of the second field effect transistor.

28. The rectifier circuit as claimed in claim 24 further comprising:
a second DC voltage terminal;
a third field effect transistor, the first source/drain terminal of which is coupled to the first AC voltage terminal and the second source/drain terminal of which is coupled to the second DC voltage terminal; and
a third comparator, the first input of which is coupled to the first AC voltage terminal, the second input of which is coupled to the second DC voltage terminal and the output of which is coupled to the gate terminal of the third field effect transistor.

29. The rectifier circuit as claimed in claim 27 further comprising:
a fourth field effect transistor, the first source/drain terminal of which is coupled to the second AC voltage terminal and the second source/drain terminal of which is coupled to the second DC voltage terminal; and
a fourth comparator, the first input of which is coupled to the second AC voltage terminal, the second input of which is coupled to the second DC voltage terminal and the output of which is coupled to the gate terminal of the fourth field effect transistor.

30. The rectifier circuit as claimed in claim 27 further comprising:
a second DC voltage terminal,
a third field effect transistor, the first source/drain terminal of which is coupled to the first AC voltage terminal and the second source/drain terminal of which is coupled to the second DC voltage terminal; and
a first inverter, the input of which is coupled to the output of the second comparator and the output of which is coupled to the gate terminal of the third field effect transistor.

31. The rectifier circuit as claimed in claim 30 further comprising:
a fourth field effect transistor, the first source/drain terminal of which is coupled to the second AC voltage terminal and the second source/drain terminal of which is coupled to the second DC voltage terminal; and
a second inverter, the input of which is coupled to the output of the first comparator and the output of which is coupled to the gate terminal of the fourth field effect transistor.

32. The rectifier circuit as claimed in claim 24 further comprising:
a second AC voltage terminal;
a second DC voltage terminal;
a second field effect transistor, the first source/drain terminal of which is coupled to the second AC voltage terminal and the second source/drain terminal of which is coupled to the first DC voltage terminal;
a third field effect transistor, the first source/drain terminal of which is coupled to the first AC voltage terminal and the second source/drain terminal of which is coupled to the second DC voltage terminal;
a third comparator, the first input of which is coupled to the first AC voltage terminal, the second input of which is coupled to the second DC voltage terminal and the output of which is coupled to the gate terminal of the third field effect transistor; and
a first inverter, the input of which is coupled to the output of the third comparator and the output of which is coupled to the gate terminal of the second field effect transistor.

33. The rectifier circuit as claimed in claim 26 further comprising:
a fourth field effect transistor, the first source/drain terminal of which is coupled to the second AC voltage terminal and the second source/drain terminal of which is coupled to the second DC voltage terminal; and
a second inverter, the input of which is coupled to the output of the first comparator and the output of which is coupled to the gate terminal of the fourth field effect transistor.

34. The rectifier circuit as claimed in claim 26 configured such that at least one of the comparators and/or at least one of the inverters can be supplied with electrical energy by means of the DC voltage at the first and/or the second DC voltage terminal.

35. The rectifier circuit as claimed in claim 26 further comprising an additional rectifier circuit that is interconnected in such a manner that at least one of the comparators and/or at least one of the inverters can be supplied with electrical energy by means of the additional rectifier circuit.

36. The rectifier circuit as claimed in claim 26 configured such that at least one of the comparators and/or at least one of the inverters can be supplied with electrical energy by means of the AC voltage at the first and/or the second AC voltage terminal.

37. The rectifier circuit as claimed in claim 25, wherein at least one of the field effect transistors is one of a group comprising a polymer field effect transistor, a silicon on insulator field effect transistor, a bulk silicon field effect transistor, a junction FET, a Fin FET and a dual gate field effect transistor.

38. The rectifier circuit as claimed in claim 24, in which the AC voltage can be provided by means of an AC voltage element.

39. The rectifier circuit as claimed in claim 38, wherein the AC voltage element is one of a group comprising an antenna, a coil and an AC voltage source.

40. The rectifier circuit as claimed in claim 24, wherein at least a part of the circuit components is implemented in one of a group comprising polymer electronics and silicon microelectronics.

41. A method for providing a rectified voltage, the method comprising:
providing an AC voltage at a first AC voltage terminal;
providing a DC voltage at a first DC voltage terminal;
coupling the first AC voltage terminal to the first DC voltage terminal only if the electrical potential at the first AC voltage terminal has a predeterminable polarity compared with a reference potential and if the amount of the electrical potential at the first DC voltage terminal is less than or equal to the amount of the electrical potential at the first AC voltage terminal.
